(19) United States
(12) Patent Application Publication
(10) Pub. No.: US 2025/0279890 A1
(43) Pub. Date: Sep. 4, 2025

(54) Improved Communication Between a Digital Key Device and a Vehicle

(71) Applicant: Bayerische Motoren Werke Aktiengesellschaft, Muenchen (DE)

(72) Inventors: Matthias FINK, Muenchen (DE); Marco HIPPLER, Muenchen (DE)

(21) Appl. No.: 19/060,897

(22) Filed: Feb. 24, 2025

(30) Foreign Application Priority Data
Mar. 1, 2024 (DE) 10 2024 105 933.8

(51) Int. Cl. H04L 9/32; H04L 9/08; H04L 9/30

(52) U.S. Cl. CPC H04L 9/321; H04L 9/083; H04L 9/0891; H04L 9/3073; H04L 9/3268; H04L 2209/84

(57) ABSTRACT

A method for communicating data between a terminal, which has a signature key pair for a vehicle, and the vehicle, is provided. A public vehicle encryption key is transmitted from the vehicle to the terminal. A public terminal encryption key is combined with an identification feature of the terminal or a third party, the combined public terminal encryption key is transmitted from the terminal to the vehicle, and the identification feature of the combined public terminal encryption key is verified by the vehicle. This enables confidential indirect communication between the vehicle and the terminal via the third party based on the vehicle encryption key and the terminal encryption key.

### CROSS REFERENCE TO RELATED APPLICATION

This application claims priority under 35 U.S.C. § 119 from German Patent Application No. 10 2024 105 933.8, filed Mar. 1, 2024, the entire disclosure of which is herein expressly incorporated by reference.

### BACKGROUND AND SUMMARY

The present invention relates to a method for communicating data between a terminal, which has a digital first signature key pair for a vehicle, on the one hand, and the vehicle, on the other hand. The present invention also relates to an arrangement having a vehicle, a terminal and a backend.

The Car Connectivity Consortium (CCC) standardizes digital vehicle key solutions. Release 3 ff. of this standard standardizes an access system consisting of
a) smart devices (also referred to as terminals in the present document) and software which
   i) carry a digital key that is embedded in a secure memory on the smart device,
   ii) provide interfaces from the secure memory to the smart device operating system, and
   iii) provide interfaces from the smart device operating system to other applications running on the smart device (for example, an app of a vehicle manufacturer),
b) a vehicle that makes it possible for carriers or users of a digital key (implemented in the smart device) to operate certain vehicle functions, and
c) backend systems which connect smart devices and vehicles to one another and provide the shared use and management of digital keys and additional services.

Digital keys can be forwarded from one terminal or smart device to another. The devices themselves as well as the server (backend) and the vehicle are involved in this. During shared use, only signature keys are exchanged between the terminal and the vehicle, whereas the terminals and the server also exchange an encryption key. If the terminal is in direct contact with the vehicle, a secure channel is set up and enables secure data exchange.

In the case of direct contact, the vehicle and the terminal can securely exchange data via a secure channel which is set up using the previously exchanged signature keys. In technical terms, the vehicle accesses a mailbox and reads and writes data from/to it. In this scenario, the vehicle assumes an active role, whereas the terminal assumes a passive role. In addition, data can be securely exchanged only when the terminal is in the immediate vicinity.

Provision is not made for confidential communication to take place between the terminal and the vehicle if both are far away from one another over a relatively long distance. For example, a second digital key belonging to a second user of the vehicle is intended to be able to be enabled by a first user even when the first user is far away from the vehicle.

The object of the present invention is therefore to enable secure communication between a smart device or terminal and a vehicle even over further distances.

According to the invention, this object is achieved by means of a method and an arrangement according to the independent claims. Advantageous developments of the invention emerge from the subclaims.

The invention therefore provides a method for communicating data between a terminal, which has a (digital) first signature key pair for a vehicle, on the one hand, and the vehicle, on the other hand. The terminal (first device) is therefore the carrier of the (digital) first signature key. It is preferably stored in a secure memory area of the terminal. The first signature key pair consists of a public and a private signature key (public key PK and secret key SK). Communication may be unidirectional communication and bidirectional communication between the terminal and the vehicle.

In a first step, a vehicle encryption key pair is provided in the vehicle for encrypting the data during transmission between the terminal and the vehicle. The vehicle therefore provides an encryption key pair having a private key and a public key. The provision may involve generating the respective key pair. After being generated, the key pair can be provided in a memory.

Furthermore, in the method according to the invention, a terminal encryption key pair is provided in the terminal for encrypting the data during transmission between the terminal and the vehicle. The terminal therefore also provides a corresponding encryption key pair. In this case too, the provision may involve generating the encryption key pair.

Furthermore, a public vehicle encryption key of the vehicle encryption key pair is transmitted from the vehicle to the terminal. The public key of the vehicle encryption key pair is therefore transmitted to the terminal or smart device. This is carried out when exchanging the public keys. The public vehicle encryption key is therefore available to the terminal.

In a further step, a public terminal encryption key of the terminal encryption key pair is combined with an identification feature of the terminal (for example, first signature key) or a third party (for example, by means of an attestation by the third party, in particular a backend). In the first case, the terminal, uses its first signature key to certify the public terminal encryption key. In the second case, the third party or the backend attests that the terminal encryption key corresponds to predefined requirements. This is necessary so that the vehicle can assume a permissible encryption key of the terminal.

The combined public terminal encryption key of the terminal encryption key pair (possibly including the attestation) is then transmitted from the terminal to the vehicle. The public terminal encryption key of the terminal is therefore available to the vehicle in a form certified or attested, for example, by the third party or the backend. The two encryption keys are therefore exchanged.

In a further step, the identification feature of the combined public terminal encryption key is verified by the vehicle. As a result, the vehicle can ensure that the attestation was issued by the third party known to it or was signed by the known terminal. In detail, terminal-specific contents (terminal signature key and terminal encryption key) can therefore be protected by a signature/attestation of the sharing device. For example, the vehicle OEM server adds its own contents to this attestation and signs the entire attestation package. The vehicle generally verifies both signatures (that of the sharing device and that of the backend).

Finally, encrypted communication takes place between the vehicle and the terminal via the third party (for example, the backend or a backend server infrastructure) based on the vehicle encryption key and the terminal encryption key. The terminal and the vehicle can therefore communicate confidentially with the aid of the shared encryption keys via third parties (for example, the backend). Indirect confidential communication via a third party is therefore possible. Although the parties know the signature keys of the respective other party, they do not know their private encryption keys. For example, encryption is necessary for applications in which secret data have to be exchanged directly between a terminal and a server over long distances, in which case the backend servers act as proxies. An example would be a PIN that can be set as an additional factor for activating a key to prevent misuse (misuse can generally be considered here to be the fact that a sharing link lands on an incorrect device or with an incorrect user or is intercepted and the like).

The terminal may be a smartphone, a bracelet, a watch, a check card (NFC card) and many other things. For example, the digital key can be stored in a secure area (for example, security chip). If appropriate, a “wallet” containing other security-critical data, for instance credit card data, is also stored there.

In one exemplary embodiment, provision is made for the public vehicle encryption key to be integrated in a configuration data container of the vehicle for transmission from the vehicle to the terminal. In particular, the data container may be a TLV (Type-Length-Value) data container. The tag describes the data format in which the data type is followed by the length of the following value. According to the CCC standard, the TLV data container 0x7F4A can be used to transmit the public vehicle encryption key.

Alternatively, the public vehicle encryption key is integrated in a vehicle key certificate for transmission from the vehicle to the terminal. The public vehicle key certificate is transmitted from the vehicle to the terminal using the TLV data container 0x7F4B, for example. The public vehicle encryption key, which is indeed integrated in the vehicle key certificate, can now also be transmitted in the same data container. The terminal can store the public vehicle encryption key. The owner pairing between the vehicle and the terminal (belonging to the proprietor or owner) is thus completed.

In a special exemplary embodiment, the public vehicle encryption key is integrated in a certificate extension according to the CCC standard (“extension device oid” or “dedicated extension oid”) for transmission from the vehicle to the terminal. This also makes it possible to achieve the situation in which the public vehicle encryption key is transmitted according to the CCC standard.

In a further exemplary embodiment, provision is made, during the combining, for the terminal to combine the public terminal encryption key with a public first signature key of the (digital) first signature key pair as an identification feature of the terminal in a key certificate (digital key certificate), wherein, in particular, an object identifier for the public first signature key and an object identifier for the public terminal encryption key are integrated in the key certificate, and the key certificate is transmitted to the vehicle for transmission of the public terminal encryption key. This makes it possible to implement a first alternative for transmitting the terminal encryption key to the vehicle. This alternative manages without the interposition of the backend. In particular, the key certificate (digital key certificate) can be generated in the terminal, in which case the key certificate comprises the object identifiers mentioned above. The vehicle can then request the certificate file from the terminal, for example, whereupon the terminal transmits the key certificate to the vehicle.

In an alternative exemplary embodiment, provision is made, for combining the public terminal encryption key with the identification feature of the third party (also called backend below for simplification), for the terminal to first of all send the public terminal encryption key to the third party, for the third party to return an attestation containing the public terminal encryption key to the terminal, and for the terminal to send the attestation containing the public terminal encryption key to the vehicle. In this case, the backend is therefore switched on, and the public terminal encryption key is checked by the backend by means of a tracking function and is attested if appropriate. If the vehicle sends a request to the terminal, the latter can transmit the public terminal encryption key to the vehicle. Finally, the vehicle can verify the attestation (including the signature of the backend) and can store the terminal encryption key. However, with regard to the attestation, the standard method in the digital key system is to pack all relevant data in the so-called attestation (that is to say a package which learns a new key in the vehicle). It would also be conceivable for the terminal to exchange the encryption key directly with the vehicle and to use a secure channel for this purpose (which was set up or verified with the aid of the signature key), or for the encryption key to have been signed in a dedicated manner. If individual data for a device are transmitted to a vehicle, for example, the backend is required for confirmation only if the vehicle cannot ensure this alone or the backend must be procedurally incorporated (for example, the backend must know that a digital vehicle key (signature key) generally exists).

According to a further exemplary embodiment, a method for communicating data between a second device, which has a second signature key pair for a vehicle, on the one hand, and the vehicle, on the other hand, is provided. The method comprises the following steps:
providing a public vehicle encryption key in a terminal for encrypting the data,
transmitting the public vehicle encryption key from the terminal to the second device,
providing a second device encryption key pair in the second device for encrypting the data during transmission between the second device and the vehicle,
transmitting a public second signature key of the second signature key pair and a public second device encryption key to a third party,
signing the public second device encryption key by means of the third party,
sending the signed public second device encryption key from the third party to the vehicle, and
encrypting communication between the vehicle and the second device via the third party based on the vehicle encryption key and the second device encryption key.

This means that a first user, for example, transmits its digital key to a second user or shares it with the latter. Such key sharing can be carried out according to the CCC standard by transmitting a TLV data container 0x7F31 which contains the public vehicle encryption key. The receiver or the second device can extract and internally store this public vehicle encryption key. After being signed by an authorized third party (for example, OEM backend server), the public second device encryption key can be transmitted to the vehicle for verification.

In a special exemplary embodiment, the terminal transmits the public vehicle encryption key in a vehicle configuration file within a key generation request to the second device. The CCC standard can therefore be used again.

In a further exemplary embodiment, provision is made for the second device to generate a second signature key pair and a second device encryption key pair, for the second device to send a public second signature key of the second signature key pair, together with a public second device encryption key of the second device encryption key pair, to the backend, and
a) after verifying the public second signature key and the public second device encryption key, for the backend to return a signed version of the public second device encryption key to the second device, and for the second device, in particular in the event of initial contact with the vehicle, to send the signed version of the public second device encryption key to the vehicle for verification (possibly for storing the public second device encryption key there), and/or
b) after verifying the public second signature key and the public second device encryption key, for the third party to return a signed version of the public second device encryption key directly to the vehicle for verification.

A second signature key pair and a second device encryption key pair can therefore first be generated or provided in the second device. So that the vehicle can assume that the two generated keys are legitimate, the public keys of both key pairs are sent to a backend, for example, using a tracking function. In the event of a positive verification, the backend signs the public second device encryption key and returns it to the second device in signed form. If the second device encounters the vehicle, the vehicle first reads the attestation containing the integrated signed second device encryption key from the second device. The vehicle can then verify the signature and store the second signature key of the second device. A second user is therefore able to operate the vehicle using a second device (digital second signature key), and the second device can confidentially communicate with the vehicle.

Alternatively, after verifying the public second signature key and the public second device encryption key, the third party can thus return a signed version of the public second device encryption key directly to the vehicle for verification. This simplified version is possible, for example, when the vehicle has a radio connection to the backend. In principle, the two alternatives may also be carried out together.

The above method for confidential communication between a first device and a vehicle can be combined with the above method for confidential communication between a second device and a vehicle.

According to the invention, the above object is also achieved by means of an arrangement having a vehicle, a terminal and a backend as components. The components are designed to carry out a method as described above.

The advantages and developments described above in connection with the method according to the invention also apply analogously to the arrangement according to the invention. Accordingly, the respective method features can be considered to be functional features of corresponding components of the arrangement.

In one development of the arrangement according to the invention, a second device is provided as a further component. The first-mentioned components, together with the further component, are then designed to carry out a method described above, in which a first device shares a digital key with a second device.

The present invention is now explained in more detail using the accompanying drawings, in which:

### BRIEF DESCRIPTION OF THE DRAWINGS

FIG. 1 shows a flowchart for transmitting an encryption key from a vehicle to a terminal (first device);

FIG. 2 shows a flowchart for transmitting an encryption key from a terminal to a vehicle;

FIG. 3 shows a flowchart for transmitting an encryption key from a terminal to a second device; and

FIG. 4 shows a flowchart for transmitting an encryption key from a second device to a vehicle.

### DETAILED DESCRIPTION OF THE DRAWINGS

The exemplary embodiments described in more detail below are preferred embodiments of the present invention.

To enable encrypted communication between a terminal and a vehicle using proxy instances, an encryption key pair is introduced on the vehicle side. This key pair is securely exchanged, together with the possibly already available key pair of the terminal, with the result that information can be confidentially exchanged from the terminal to the vehicle and vice versa via the backend server infrastructure.

The examples below show the exchange of the encryption key between the vehicle F, on the one hand, and a first device E1 or a second device E2, on the other hand. The first device E1 and the second device E2 may be, for example, a smartphone, an NFC card, a bracelet, a watch and the like, which can be carried by a first user and/or a second user.

A vehicle typically does not have an encryption key, but rather only a digital vehicle key, i.e., a signature key. However, the vehicle can generate an encryption key and can make it available to a terminal (first device E1) during owner pairing.

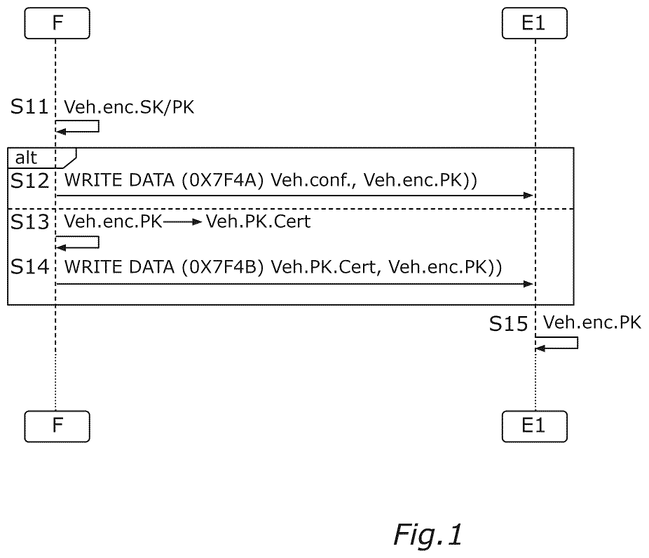

FIG. 1 shows, in an example, the transmission of a vehicle encryption key from the vehicle F to the first device E1. In an optional step S11, the vehicle F creates a vehicle encryption key pair Veh.Enc.SK/PK, wherein the key pair has a private key SK (secret key) and a public key PK (public key).

During owner pairing, the encryption key can be added to a vehicle or endpoint configuration (data container 0x7F4A). The endpoint configuration contains the vehicle signature key (subcontainer 0x5B, vehicle certificate containing a public key). This is shown in FIG. 1 as a first alternative according to step S12. Specifically, the command “WRITE DATA” is thus used to write the data container 0x7F4A containing the vehicle configuration Veh.conf., together with the public vehicle encryption key Veh.Enc.PK, to the terminal or first device E1.

As an alternative to step S12, steps S13 and S14 can be carried out. In step S13, the public vehicle encryption key Veh.enc.PK is added to the public vehicle certificate Veh.PK.Cert to tie the encryption key to the vehicle identity. The vehicle encryption key may be part of a certificate, for example, and may be integrated in a certificate extension.

Finally, the public vehicle encryption key Veh.enc.PK can be stored in the first device E1 according to step S15.

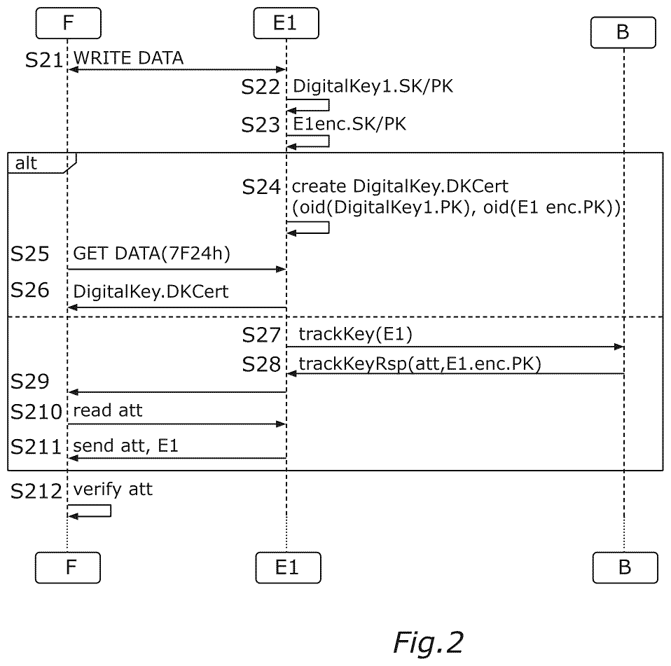

The example from FIG. 2 shows how the public encryption key of the terminal E1 can be transmitted to the vehicle F. This can also be carried out during owner pairing between the vehicle F and the terminal E1.

Step S21 combines steps S11 to S15 according to FIG. 1. In step S22, a digital first device or terminal key pair DigitalKey1.SK/PK is generated in the terminal E1. In step S23, a terminal encryption key pair E1.enc.SK/PK is generated. The public terminal encryption key PK can be transmitted from the terminal E1 to the vehicle F using two alternatives: Steps S24 to S26 or steps S27 to S211.

In the first alternative, a digital key certificate DigitalKey.DKCert is generated in the terminal E1 according to step S24. This certificate comprises an object identifier oid for the public digital first signature key DigitalKey1.PK and the object identifier oid for the public terminal encryption key E1.enc.PK. The public terminal encryption key is therefore combined or certified with the public first signature key DigitalKey1.PK (identification feature of the terminal). In step S25, the vehicle F uses the command GET DATA to request the certificate from the terminal E1. The latter then sends the digital key certificate DigitalKey.DKCert. to the vehicle F in step S26. The vehicle F can extract the key from the certificate extension if necessary.

In the alternative transmission according to steps S27 to S211, the public terminal encryption key E1.enc.PK is not appended to a certificate, but rather is sent by the backend B as part of key monitoring (track key function). For this purpose, the public terminal encryption key E1.enc.PK is first of all transmitted to the backend B in step S27 using the key checking function TrackKey. The backend B is preferably the vehicle OEM backend, possibly including a KTS (key tracking server). In step S28, the backend B sends a response TrackKeyRsp to the terminal E1. This response comprises an attestation att signed by the backend, including the public terminal encryption key. The public terminal encryption key is therefore combined or attested with the signature (identification feature) of the backend.

In step S29, the first device E1 can first approach the vehicle F. In step S210, the vehicle F reads the attestation att from the terminal E1 or requests it there. In step S211, the terminal E1 sends the signed attestation att containing the embedded public terminal encryption key E1.enc.PK to the vehicle F. The key E1.enc.PK is therefore part of E1.att, that is to say is embedded in E1.att, and E1.enc.PK is protected by signatures.

Finally, the vehicle F can verify the attestation att in step S212 and can store the key(s).

The second alternative according to steps S27 to S211 can be summarized as follows: After the owner pairing sequence has been completed on the vehicle side, the terminal E1 transmits its status to the backend server. In order to activate the coupled key in the vehicle, the vehicle OEM server always sends a confirmation (attestation) to the vehicle F. Alternatively, the encryption key or encryption code in this attestation can also be forwarded from the backend (which already knows the encryption key of the terminal) to the vehicle.

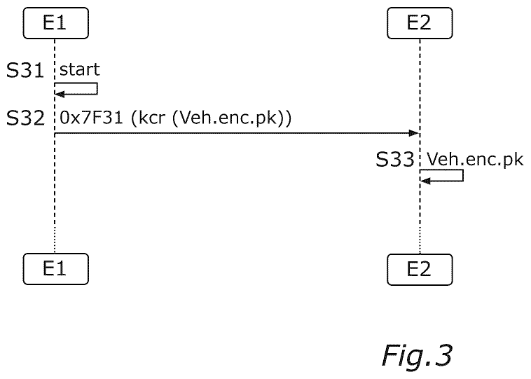

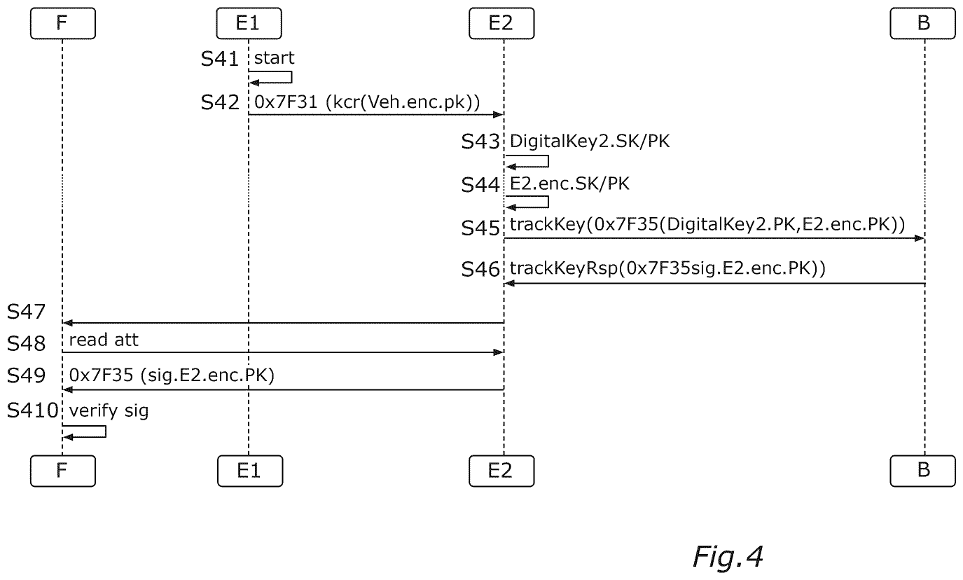

FIGS. 3 and 4 now show an example of the key exchange when a key is intended to be transmitted from the first device E1 to a second device E2 or from a first user to a second user. The key forwarding is started in step S31. If a digital key is forwarded to another device (here the second device E2), the public vehicle encryption key is also forwarded in this example as part of the endpoint configuration (0x7F27) within the key creation request kcr (0x7F31), from the first device E1 to the second device E2. The second device E2 extracts the public vehicle encryption key in step S33 and stores it.

According to FIG. 4, the encryption key is transmitted from the second device E2 to the vehicle F. For this purpose, the first device E1, for example, starts the key exchange (corresponds to step S31) in step S41. In step S42, a key creation request kcr, including the public vehicle encryption key Veh.enc.PK, is transmitted from the first device E1 to the second device E2 in a manner corresponding to step S32. In step S43, the second device E2 generates a second signature key pair DigitalKey2.SK/PK. In step S44, the second device E2 generates a second device encryption key pair E2.enc.SK/PK.

In step S45, the second device E2 now sends a track key request to the backend B. This request relates to the public digital second key DigitalKey2.PK and the public second device encryption key E2.enc.PK. To then communicate a new common digital key to the vehicle F, the backend OEM server of the vehicle F sends a certificate (signature) to the vehicle F. This certificate has a different format to the owner attestation from step S28. For example, the signature contains the signature key of the second device E2. This certificate must be extended such that, in addition to the signature key of the first device E1 or the second device E2, it also contains the encryption key of the second device E2.

The latter can be specifically implemented by means of steps S46 to S49. In step S46, the backend B sends a track key response TrackKeyRsp, including a signed public second device encryption key sig.E2.enc.PK. According to step S47, the second device E2 can first approach the vehicle F. In step S48, the vehicle F requests an attestation att from the second device E2. The latter sends the public second device encryption key sig.E2.enc. PK signed by the backend as the response in step S49. In step S410, the vehicle F can verify the signature sig.

As the examples show, an encryption key pair is used for the encrypted communication between the terminal and the vehicle using proxy instances. This key pair can be securely exchanged, as a result of which information can be confidentially transmitted between the terminal and the vehicle via the backend server infrastructure.

### LIST OF REFERENCE SIGNS

B Backend
E1 Terminal or first device
E2 Second device
F Vehicle
S11 to S15 Steps
S21 to S29 Steps
S210 to S212 Steps
S31 to S33 Steps
S41 to S49 Steps
S410 Step

What is claimed is:

1. A method for communicating data between a terminal, which has a first signature key pair for a vehicle, and the vehicle, the method comprising:
providing a vehicle encryption key pair in the vehicle for encrypting the data during transmission between the terminal and the vehicle;
providing a terminal encryption key pair in the terminal for encrypting the data during transmission between the terminal and the vehicle;
transmitting a public vehicle encryption key of the vehicle encryption key pair from the vehicle to the terminal;
combining a public terminal encryption key of the terminal encryption key pair with an identification feature of the terminal or a third party;
transmitting the combined public terminal encryption key from the terminal to the vehicle;
verifying the identification feature of the combined public terminal encryption key by means of the vehicle; and
encrypting communication between the vehicle and the terminal via the third party based on the vehicle encryption key and the terminal encryption key.

2. The method according to claim 1, wherein the public vehicle encryption key is integrated in a configuration data container of the vehicle for transmission from the vehicle to the terminal.

3. The method according to claim 1, wherein the public vehicle encryption key is integrated in a vehicle key certificate for transmission from the vehicle to the terminal.

4. The method according to claim 3, wherein the public vehicle encryption key is integrated in a certificate extension according to the CCC standard for transmission from the vehicle to the terminal.

5. The method according to claim 1, wherein during the combining, the terminal combines the public terminal encryption key with a public first signature key of the first signature key pair as an identification feature of the terminal in a key certificate, wherein an object identifier for the public first signature key and an object identifier for the public terminal encryption key are integrated in the key certificate, and the key certificate is transmitted to the vehicle for transmission of the public terminal encryption key.

6. The method according to claim 2, wherein during the combining, the terminal combines the public terminal encryption key with a public first signature key of the first signature key pair as an identification feature of the terminal in a key certificate, wherein an object identifier for the public first signature key and an object identifier for the public terminal encryption key are integrated in the key certificate, and the key certificate is transmitted to the vehicle for transmission of the public terminal encryption key.

7. The method according to claim 1, wherein for combining the public terminal encryption key with the identification feature of the third party, the terminal first sends the public terminal encryption key to the third party, the third party returns an attestation containing the public terminal encryption key to the terminal, and the terminal sends the attestation containing the public terminal encryption key to the vehicle.

8. The method according to claim 2, wherein for combining the public terminal encryption key with the identification feature of the third party, the terminal first sends the public terminal encryption key to the third party, the third party returns an attestation containing the public terminal encryption key to the terminal, and the terminal sends the attestation containing the public terminal encryption key to the vehicle.

9. The method according to claim 7, wherein the attestation is provided with a signature of the third party.

10. The method according to claim 8, wherein the attestation is provided with a signature of the third party.

11. A method for communicating data between a second device, which has a second signature key pair for a vehicle, and the vehicle, the method comprising:
providing a public vehicle encryption key in a terminal for encrypting the data;
transmitting the public vehicle encryption key from the terminal to the second device;
providing a second device encryption key pair in the second device for encrypting the data during transmission between the second device and the vehicle;
transmitting a public second signature key of the second signature key pair and a public second device encryption key to a third party;
signing the public second device encryption key by the third party;
sending the signed public second device encryption key from the third party to the vehicle; and
encrypting communication between the vehicle and the second device via the third party based on the vehicle encryption key and the second device encryption key.

12. The method according to claim 11, wherein the terminal transmits the public vehicle encryption key in a vehicle configuration file within a key generation request to the second device.

13. The method according to claim 11, wherein
a) after verifying the public second signature key and the public second device encryption key, the third party returns a signed version of the public second device encryption key to the second device, and the second device sends the signed version of the public second device encryption key to the vehicle for verification, and/or
b) after verifying the public second signature key and the public second device encryption key, the third party returns a signed version of the public second device encryption key directly to the vehicle for verification.

14. The method according to claim 12, wherein
a) after verifying the public second signature key and the public second device encryption key, the third party returns a signed version of the public second device encryption key to the second device, and the second device sends the signed version of the public second device encryption key to the vehicle for verification, and/or
b) after verifying the public second signature key and the public second device encryption key, the third party returns a signed version of the public second device encryption key directly to the vehicle for verification.

15. The method according to claim 13, wherein the second device sends the signed version of the public second device encryption key, together with a second device signature key of the second device, to the vehicle.

16. The method according to claim 14, wherein the second device sends the signed version of the public second device encryption key, together with a second device signature key of the second device, to the vehicle.

17. The method according to claim 1, further comprising:
communicating data between a second device, which has a second signature key pair for the vehicle, and the vehicle, including:
transmitting the public vehicle encryption key from the terminal to the second device;
providing a second device encryption key pair in the second device for encrypting the data during transmission between the second device and the vehicle;
transmitting a public second signature key of the second signature key pair and a public second device encryption key to a third party;
signing the public second device encryption key by the third party;
sending the signed public second device encryption key from the third party to the vehicle; and
encrypting communication between the vehicle and the second device via the third party based on the vehicle encryption key and the second device encryption key.

18. An arrangement having a vehicle, a terminal and a third party as components, wherein the components are configured to carry out a method according to claim 1.

19. An arrangement having a vehicle, a terminal, a third party and a second device as components, wherein the components are configured to carry out a method according to claim 11.
